(19) United States
(12) Patent Application Publication
(10) Pub. No.: US 2026/0260188 A1
(43) Pub. Date: Sep. 3, 2026

(54) Autopilot Supervision for Human and Artificial Intelligence Customer Service Agents

(71) Applicant: Nextiva, Inc., Scottsdale, AZ (US)

(72) Inventors: Raymond Allan Harker, Phoenix, AZ (US); Senthil Velayutham, Frisco, TX (US); Chinmay Joshi, Manor, TX (US); Danielle Kavanaugh, Park Ridge, IL (US); Paul Kida, Prescott, AZ (US)

(21) Appl. No.: 19/464,121

(22) Filed: Jan. 29, 2026

Related U.S. Application Data
(60) Provisional application No. 63/752,238, filed on Jan. 31, 2025.

(51) Int. Cl. G06Q 10/0631; G06Q 30/015

(52) U.S. Cl. CPC G06Q 10/063116; G06Q 10/063114; G06Q 30/015

(57) ABSTRACT

A system and method are disclosed for intervening in customer service interactions. The method comprises monitoring open interactions between agent systems and customer devices, tracking a duration of the open interactions to determine a relative priority for resolution, and assigning a resolution priority to the open interactions based on the duration per communication type, sorting the open interactions based on interaction characteristics, generating and presenting a user interface comprising the sorted open interactions, and transmitting data to an agent system.

### CROSS-REFERENCE TO RELATED APPLICATIONS

The present disclosure is related to that disclosed in the U.S. Provisional Application No. 63/752,238, filed Jan. 31, 2025, entitled “Autopilot Supervision for Human and Artificial Intelligence Customer Service Agents.” U.S. Provisional Application No. 63/752,238 is assigned to the assignee of the present application. The present invention hereby claims priority under 35 U.S.C. §119(e) to U.S. Provisional Application No. 63/752,238.

### TECHNICAL FIELD

The present disclosure relates generally to customer interaction management and specifically to monitoring customer service interactions to enable supervisor intervention.

### BACKGROUND

In customer support and customer service environments, such as call centers, support centers and the like, many customer service agents work on multiple new and existing support tickets every day. To work in existing customer service systems, agents must manually go through every ticket to determine where it was left off and must receive instructions from supervisors concerning upcoming work schedules and work planning which may consume a significant amount of time. Further, in existing customer service systems a significant amount of manual effort is required to create filters for upcoming engagements or interactions that agents need to work on. In existing customer service systems, the workflows for such customer service agents are often complicated and involve juggling multiple tasks for multiple tickets at a time which makes it difficult to accurately work on every ticket or accept new tickets into an existing workload, creates barriers to collaboration with internal stakeholders and causes difficulties in finding the correct resources to resolve tickets, in addition to creating an environment where the customer service agent may make errors such as mistakenly entering information into an incorrect ticket or otherwise losing track of the progress of tickets. For these reasons and more, existing customer service systems create inefficient workflows for customer service agents, encourage errors and miscommunications in customer interactions and require frequent manual intervention by agents and supervisors alike, all of which is undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates an example interaction system, according to an embodiment;

FIG. 2 illustrates the supervisor system and an agent system of FIG. 1 in greater detail, according to an embodiment;

FIG. 3 illustrates an example method for intervening in customer service interactions, according to an embodiment;

FIG. 4 illustrates a supervision display, according to an embodiment;

FIG. 5 illustrates an engagement preview display, according to an embodiment and

FIG. 6 illustrates an intervention display, according to an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Embodiments provide systems and methods for supervising live interactions between a set of customer service systems and end user systems, which may be associated with AI or human customer service agents and customers or end users, respectively. Embodiments have the ability to prioritize a list of interactions based on how much attention is needed or a priority of resolution, allowing more sensitive or potentially negative interactions to be resolved before lower priority interactions. Embodiments enable supervisors or managers to have awareness of different categories of sub-optimal interactions based on the business preferences, such as interactions with undesired language, deteriorating sentiment, value of customer, legal risk or other sub-optimal interactions. Embodiments may provide a user with valuable information about each live interaction including duration, sentiment, AI summaries, enabling the user to easily determine whether or not attention is needed for a particular interaction. Embodiments may enable supervisors to virtually view a ticket from an agent's perspective in order to see all the context and guidance they are being provided before attempting to intervene.

Use of embodiments may allow supervisors to actively monitor AI agents with closer attention than is possible with existing customer service management systems, such as by alerting supervisors of negative experiences and giving the supervisor the information needed to assess the situation and intervene. Embodiments may allow supervisors to monitor many human and AI agents simultaneously, which is not possible in existing customer service management systems. Use of embodiments allows supervisors to alter the output of AI agents to nudge an interaction in a preferred direction and to privately message human agents to provide suggestions only visible to the human agent without the human agent needing to leave their ticket. Embodiments may provide a record of past interventions by supervisors to enable complete review of interactions and interventions.

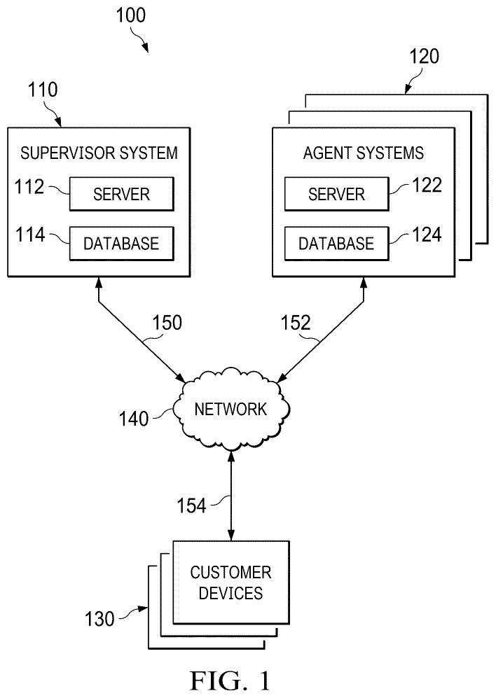

FIG. 1 illustrates interaction system 100, according to an embodiment. Interaction system 100 comprises supervisor system 110, one or more agent systems 120, one or more customer devices 130, network 140 and one or more communication links 150-154. Although a single supervisor system 110, one or more agent systems 120, one or more customer systems 130, a single network 140 and one or more communication links 150-154 are shown and described, embodiments contemplate any number of supervisor systems 110, agent systems 120, customer devices 130, networks 140 or communication links 150-154, according to particular needs.

According to an embodiment, supervisor system 110 comprises server 112 and database 114. Although supervisor system 110 is illustrated in FIG. 1 as comprising a single server 112 and a single database 114, embodiments contemplate supervisor system 110 including any suitable number of servers 112 or databases 114, serverless computing options or data stores, internal to or externally coupled with supervisor system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. In embodiments, supervisor system 110 may be used to monitor interactions between one or more agent systems 120 and one or more customer devices 130 and may additionally intervene in such interactions by transmitting instructions to one or more agent systems 120, as described in further detail below.

According to an embodiment, one or more agent systems 120 may be used by customer service agents, customer experience agents or any other agent or any entity which communicates with customers, such as call centers, help desks or other entities. In embodiments, agent systems 120 may be used to communicate with customers of an entity operating agent system 120 or the customers of another entity. In embodiments, agent systems 120 may comprise or be operated by one or more machine learning (ML) or artificial intelligence (AI) agents configured to respond to customer communications. One or more agent systems 120 may operate on one or more computers comprising one or more servers 122 and one or more databases 124 or other data storage arrangements at one or more locations which are integral to or separate from the hardware and/or software that supports interaction system 100.

According to an embodiment, one or more customer devices 130 comprise devices or systems associated with customers or other end users such as, for example, customers, buyers, sellers, retailers, or any other business, enterprise or entity using customer service or customer relationship services provided by interaction system 100 and agent systems 120. In embodiments, customer devices 130 may include communication devices that provide a channel of communication between customers and agents systems 120, such as voice channels, video channels, email channels, text channels, chat channels or any other communication channel.

According to an embodiment, network 140 includes the Internet, telephone lines, any appropriate local area networks LANs, MANs, or WANs, and any other communication network coupling supervisor system 110, one or more agent systems 120 and one or more customer devices 130. For example, data may be maintained by supervisor system 110, one or more agent systems 120 and one or more customer devices 130at one or more locations external to supervisor system 110, one or more agent systems 120 and one or more customer devices 130and made available to supervisor system 110, one or more agent systems 120 and one or more customer devices 130 using network 140 or in any other appropriate manner. Those skilled in the art will recognize that the complete structure and operation of network 140 and other components within interaction system 100 are not depicted or described. Embodiments may be employed in conjunction with known communications networks and other components.

According to an embodiment, supervisor system 110, one or more agent systems 120 and one or more customer devices 130 are coupled with network 140 using the one or more communications links 150-154, which may be any wireless or other link suitable to support data communications between supervisor system 110, one or more agent systems 120 and one or more customer devices 130 and network 140. Although one or more communication links 150-154 are shown as generally coupling supervisor system 110, one or more agent systems 120 and one or more customer devices 130 with network 140, supervisor system 110, one or more agent systems 120 and one or more customer devices 130 may communicate directly with each other according to particular needs.

According to an embodiment, supervisor system 110, one or more agent systems 120 and one or more customer devices 130 may each operate on one or more computers or computer systems that are integral to or separate from the hardware and/or software that support interaction system 100. In addition or as an alternative, one or more users, such as end users or agents may be associated with interaction system 100 including supervisor system 110, one or more agent systems 120 and one or more customer devices 130. These one or more users may include, for example, one or more computers programmed to autonomously handle monitoring customer relationships and/or one or more related tasks within interaction system 100. As used herein, the term “computer” or “computer system” includes any suitable input device, such as a keypad, mouse, touch screen, microphone, or other device to input information. Any suitable output device that may convey information associated with the operation of interaction system 100, including digital or analog data, visual information, or audio information. Furthermore, the computer includes any suitable fixed or removable non-transitory computer-readable storage media, such as magnetic computer disks, CD-ROM, or other suitable media to receive output from and provide input to interaction system 100. The computer also includes one or more processors and associated memory to execute instructions and manipulate information according to the operation of interaction system 100.

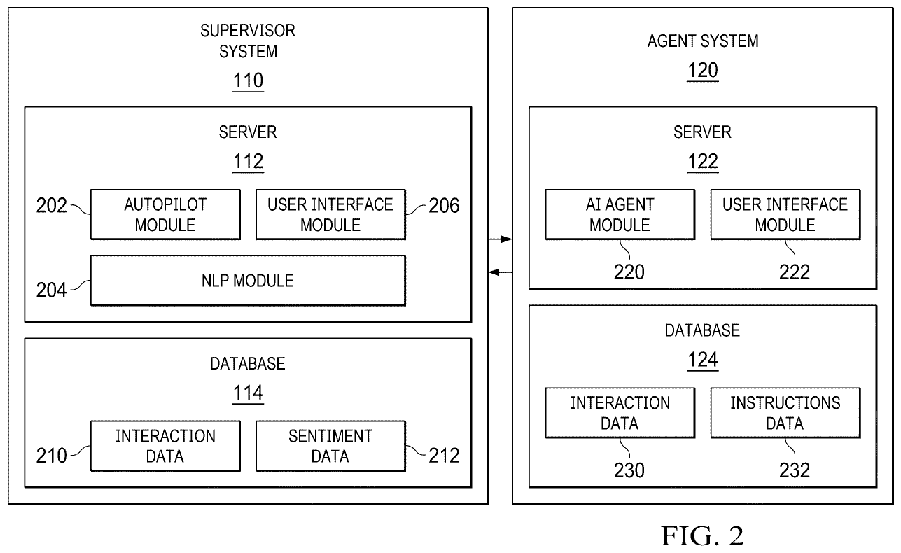

FIG. 2 illustrates supervisor system 110 and agent system 120 of FIG. 1 in greater detail, according to an embodiment. Supervisor system 110 may comprise server 112 and database 114, as described above. Although supervisor system 110 is shown as comprising a single server 112 and a single database 114, embodiments contemplate any suitable number of servers or databases internal to or externally coupled with supervisor system 110.

Server 112 comprises autopilot module 202, NLP module 204 and user interface module 206. Although server 112 is illustrated and described as having several distinct and discrete modules performing various functions or tasks, embodiments contemplate the functions of server 112 and/or the various modules being performed by any number of software or hardware modules, applications or sub-routines including fewer than or more than the number of illustrated modules, according to needs. Although server 112 is shown and described as comprising a single autopilot module 202, a single NLP module 204 and a single user interface module 206, embodiments contemplate any suitable number or combination of these located at one or more locations, local to, or remote from supervisor system 110, such as on multiple servers or computers at one or more locations in interaction system 100.

Database 114 may comprise one or more databases or other data storage arrangements at one or more locations, local to, or remote from, server 112. Database 114 comprises, for example, interaction data 210 and sentiment data 212. Although database 114 is shown and described as comprising interaction data 210 and sentiment data 212, embodiments contemplate any suitable number or combination of data, located at one or more locations, local to, or remote from, supervisor system 110, according to particular needs. While the illustrated data is shown within a single database 114 for simplicity of explanation, in embodiments data may be stored separately either physically or logically for data security, data privacy, data integrity and confidentiality purposes.

In an embodiment, autopilot module 202 monitors all open interactions between agents, including human agents and AI agents, and customers or end users. Autopilot module 202 may monitor and record various characteristics of interactions, including agent name, end user ID, queue or interaction category, communication channel and duration. In embodiments, autopilot module 202 may classify the duration of interactions according to priority of resolution, such as normal priority, elevated priority, high priority and urgent priority, although other categories of priority may be used according to needs. In embodiments where duration is classed into different priority levels, autopilot module 202 may distinguish between duration based on the communication channel. For example, an SMS or chat interaction may have a longer duration before being considered to have elevated priority, compared to a phone call or video call interaction, which may be expected to be resolved more quickly. In embodiments, autopilot module 202 may also track the sentiment of an interaction in real time using output of NLP module 204, as described in further detail below. Autopilot module 202 may also analyze the content of an interaction to generate a summary of the interaction. For example, autopilot module 202 may utilize one or more AI or ML models or algorithms to process text data to generate a summary of the text and may also auto-transcribe video data or audio data into text for processing by such modules. Autopilot module 202 may further sort interactions according to the tracked interactions in order to present a sorted list to users which may indicate a priority of interactions, such as interactions with a low sentiment, interactions with a high duration or interactions which otherwise have a high priority for resolution. In embodiments, autopilot module 202 may apply weights to the different characteristics in order to sort the interactions, such as by applying higher weights to sentiment scores and lower weights to duration.

In an embodiment, natural language processing (NLP) module 204 performs one or more NLP processing techniques to determine a sentiment score for a customer service interaction. For example, NLP module 204 may utilize one or more NLP modules to analyze text input to determine whether the text input is positive, neutral or negative, although NLP module 204 may also analyze video input, audio input or may perform speech-to-text processing to generate text input from video input or audio input in order to analyze the sentiment of the video input or the audio input. The determined sentiment scores for the interactions may be used, for example, to sort the interactions based on a priority of resolving interactions, such as to prioritize the resolution of interactions with negative sentiment scores. When processing text or other natural language data of the NLP module may utilize one or more NLP algorithms, models or techniques, including support vector machines (SVMs), term frequency (TF) models, term frequency inverse document frequency (TF-IDF) models, bag-of-words models, logistic regression models, Naïve Bayes models, decision trees, hidden Markov models, convolutional neural networks, recurrent neural networks, auto-encoder models or NLP transformers, although other NLP techniques may be used according to needs.

In an embodiment, user interface module 206 generates and displays a user interface (UI), such as, for example, a graphical user interface (GUI), that displays interaction data, sentiment data or any other data of supervisor system 110 in tables, charts, graphs, histograms, or any other visual representations of data of supervisor system 110. According to embodiments, user interface module 206 displays a GUI comprising interactive graphical elements for selecting interactions monitored by autopilot module 202 and, in response to the selection, allowing the user to view further details of the interaction and to intervene in the interaction, such as by sending instructions or suggestions to the human agent or AI agent associated with the interaction. In embodiments, user interface module 206 may also display a GUI comprising interactive graphical elements for selecting data of any kind stored in database 114, and, in response to the selection, may display the selected data on one or more display devices. In embodiments, user interface module 206 may generate non-visual interfaces, such as voice-based personal assistants or email messages or other text-based messages, and present interaction information and intervention options to users over such voice-based or text-based interfaces.

In an embodiment interaction data 210 comprises data of interactions between customer service agents and customers and end users, including data by with the interactions may be sorted for priority of resolution. For example, interaction data 210 may comprise agent names or IDs of both human and AI agents, end user or customer IDs including contact information, queue or interaction category such as sales, support, VIP customers or other categories, communication channel such as call, chat, SMS, video call or any other communication channel, interaction duration, transcripts or other content of the interactions including recorded video or audio and summaries of interaction content as described in further detail above. In embodiments, interaction data 210 may be generated by autopilot module 202 by monitoring interactions and used by autopilot module 202 to sort interactions according to priority of resolution. Although interaction data 210 is shown in database 114, in other embodiments interaction data 210 may be stored in databases 144 of agent systems 120, databases 134 of cloud data stores 130 or any other database or data storage device without or outside of interaction system 100.

In an embodiment sentiment data 212 comprises sentiment scores for interactions, which may be classified into one or more sentiment categories, such as positive, neutral or negative, although in other embodiments or more fewer sentiment categories may be used, according to needs. The sentiment scores may be based on an AI or ML sentiment analysis of text or other natural language data and may represent an estimation of an end user's or customer's attitude or feeling towards the interaction, such as whether the interaction has been generally positive or if the interaction has been generally negative. In embodiments, sentiment data 212 may be generated by NLP module 204 and used by autopilot module 202 to sort interactions based on resolution priority and further used by user interface module 206 to display sentiment scores to users.

Agent system 120 may comprise server 122 and database 124, as described above. Although agent system 120 is shown as comprising a single server 122 and a single database 124124, embodiments contemplate any suitable number of servers 122 or databases 124 internal to or externally coupled with supervisor system 110.

Server 122 comprises AI agent module 220 and user interface module 222. Although server 122 is illustrated and described as having several distinct and discrete modules performing various functions or tasks, embodiments contemplate the functions of server 122 and/or the various modules being performed by any number of software or hardware modules, applications or sub-routines including fewer than or more than the number of illustrated modules, according to needs. Although server 122 is shown and described as comprising a single AI agent module 220 and a single user interface module 222, embodiments contemplate any suitable number or combination of these located at one or more locations, local to, or remote from agent system 120, such as on multiple servers or computers at one or more locations in interaction system 100.

Database 124 may comprise one or more databases or other data storage arrangements at one or more locations, local to, or remote from, server 122. Database 124 comprises, for example, interaction data 230 and instructions data 232. Although database 124 is shown and described as comprising interaction data 210 and instructions data 232, embodiments contemplate any suitable number or combination of data, located at one or more locations, local to, or remote from, agent system 120, according to particular needs. While the illustrated data is shown within a single database 124 for simplicity of explanation, in embodiments data may be stored separately either physically or logically for data security, data privacy, data integrity and confidentiality purposes.

In an embodiment, AI agent module 220 serves as an AI customer service agent to automatically process and respond to messages or any other communications from customers or end users. For example. AI agent module 220 may utilize one or more NLP processing techniques to analyze text input and natural language input from end users, such as speech, utterances, body language or any other natural language input in order to determine the meaning of end user messages and generate response to such input. In embodiments, AI agent module 220 may receive instructions from supervisor system 110 via autopilot module 202 to steer interactions in different directions, such as by suggesting new resolution options to present to end users or providing additional information or explanations to end users. In embodiments where a human agent is conducting an interaction with an end user, AI agent module 220 may perform interaction assistant functions, such as by monitoring end user sentiment, providing summaries of interaction content and providing the human agent with response options or templates.

In an embodiment, user interface module 222 generates and displays a user interface (UI), such as, for example, a graphical user interface (GUI), that displays interaction data, instructions data or any other data of agent system 120 in tables, charts, graphs, histograms, or any other visual representations of data of agent system 120. According to embodiments, user interface module 222 displays a GUI comprising interactive graphical elements for selecting interaction and, in response to the selection, allowing the user to continue an interaction such as by entering messages to a customer or end user, or to view further details of the interaction and instructions sent from a supervisor. In embodiments, user interface module 222 may also display a GUI comprising interactive graphical elements for selecting data of any kind stored in database 124, and, in response to the selection, may display the selected data on one or more display devices. In embodiments, user interface module 222 may generate non-visual interfaces, such as voice-based personal assistants or email messages or other text-based messages, and present interaction information and instructions from supervisors to users over such voice-based or text-based interfaces.

In an embodiment interaction data 230 comprises data of interactions between customer service agents and customers and end users, including data by with the interactions may be sorted for priority of resolution. For example, interaction data 230 may comprise agent names or IDs of both human and AI agents, end user or customer IDs including contact information, queue or interaction category such as sales, support, VIP customers or other categories, communication channel such as call, chat, SMS, video call or any other communication channel, interaction duration, transcripts or other content of the interactions including recorded video or audio and summaries of interaction content as described in further detail above. In embodiments, interaction data 230 may be received from supervisor system 110 or generated by AI agent module 220 by tracking interactions and may be used by AI agent module 220 to perform AI assistant functions for customer service agents as described in further detail above. Although interaction data 230 is shown database 124, in other embodiments interaction data 230 may be stored in database 114, databases 134 of cloud data stores 130 or any other database or data storage device within or outside of interaction system 100.

In an embodiment instructions data 232 comprises instruction data received by agent system 120 from supervisor system 110 indicating intervention instructions by a supervisor. For example, instructions data 232 may include messages from supervisors to human agents indicating how to respond to end users and may also include prompts, instructions or commands to AI agents indicating how an interaction should be steered, additional resolution options that the AI agent should present to the end user or additional information that the AI agent should provide to the end user. In embodiments, instructions data 232 may be received from autopilot module 202 of supervisor system 110 and used by AI agent module 220 to conduct interactions with end users and by user interface module 222 to present instructions to human agents.

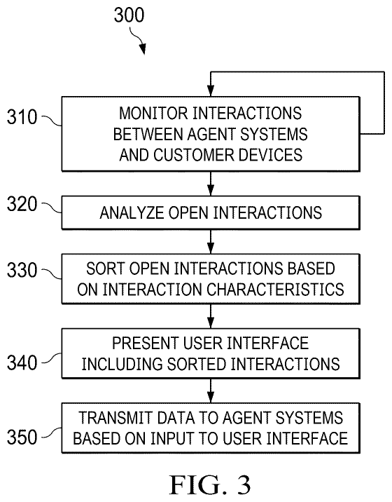

FIG. 3 illustrates method 300 for intervening in customer service interactions, according to an embodiment. Method 300 may be performed by supervisor system 110, such as supervisor system 110 of FIG. 1. Method 300 proceeds by one or more activities 310-350, which although described in a particular order may be performed in one or more permutations, combinations, orders, or repetitions, according to particular needs. Various steps through method 300 may be weighted or rewarded in order to use data collected during method 300 as training data for one or more machine learning or artificial intelligence models as described in further detail above.

At first activity 310 supervisor system 110 monitors interactions between one or more agent systems 120 and one or more customer devices 130 and tracks data of the interactions including duration, sentiment and summaries of the interactions as described in further detail below. Supervisor system 110 may monitor all interactions between all agent systems 120 or may only monitor interactions involving a subset of agent systems 120 assigned to supervisor system 110. Supervisor system 110 may continuously monitor interactions throughout the operation of method 300 in order to keep interaction data up to date throughout the display of information to users of supervisor system 110.

At second activity 320 supervisor system 110 analyzes the open interactions monitored at first activity 310. For example, supervisor system 110 may track the duration of the open interactions to determine a relative priority for resolution, and assigning a resolution priority to the open interactions based on the duration per communication type, as described in further detail above. Although duration is presented as an example for simplicity, supervisor system 110 may also analyze other characteristics of open interactions, such as sentiment of interactions and AI summaries of interaction content, according to needs.

At third activity 330 supervisor system 110 sorts the open interactions based on one or more interaction characteristics analyzed at second activity 320. For example, supervisor system 110 may generate a composite priority score for each interaction based on characteristics including communication channel, duration and sentiment, although fewer or additional characteristics may be considered when generating a composite priority score. As an example only and not by way of limitation, supervisor system 110 may generate a duration priority score based on the duration of an interaction and the communication channel of the interaction, where the communication channels have different thresholds for priority score, such as longer durations being tolerated for channel such as SMS or chat, while similar duration interactions across channels such as video calls or phone calls are assigned higher priority scores. Continuing this example, supervisor system 110 may determine the composite priority score by assigning different weights to the duration priority score and the sentiment priority score, and thereafter sorting all interactions according to their composite priority scores.

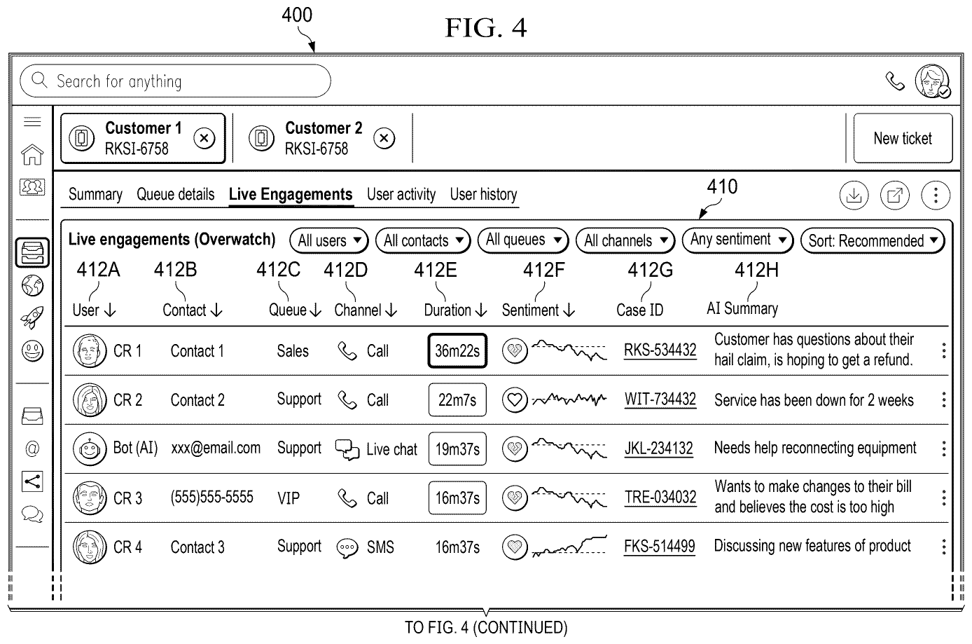

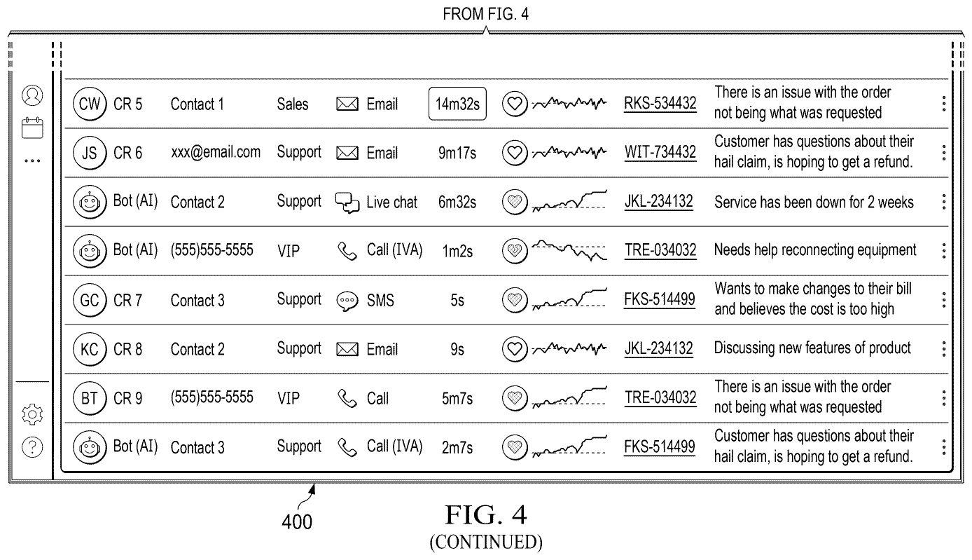

At fourth activity 340 supervisor system 110 generates and presents a user interface, such as a GUI, to a user, such as a supervisor or manger, including the interactions sorted according to the third activity. For example, example GUIs that may be displayed to users of supervisor system 110 are shown and described below with respect to FIGS. 4, 5 and 6. In embodiments, the user interface may be configured to accept input from the user, such as selecting one or more interactions and transmitting instructions or other messages to the AI agent or human agent assigned to interactions.

At fifth activity 350 supervisor system 110, based on input received from the user via the user interface presented at fourth activity 340, transmits data to at least one agent system 120. For example, the transmitted data may include instructions for human or AI agents assigned to interactions, allowing the user of supervisor system 110 to intervene in customer service interactions, including customer service interactions involving AI agents which cannot be managed accurately using existing customer service management systems.

FIG. 4 illustrates supervision display 400, according to an embodiment. Supervision display 400 may be generated by supervisor system 110 of FIG. 1 and displayed via user interface module 206 as described in further detail above. In embodiments, supervision display 400 may be displayed to a supervisor of interaction system 100, such as a customer service supervisor or a customer relationship management supervisor.

Supervision display 400 includes live engagement panel 410 displaying information of a set thirteen open interactions between customer service agents (both human and AI) monitored by supervisor system 110. Live engagement panel 410 displays information including user 412A (an ID of the human agent or AI agent assigned to an interaction or ticket), contact 412B (an ID and/or contact information of an end user associated with the interaction or ticket), queue 412C (the category or classification of the interaction or ticket), channel 412D, duration 412E, sentiment 412F, case ID 412G and AI summary 412H of the content of the interaction or ticket. Information of live engagement panel 410 may be color coded to indicate resolution priority of each interaction or ticket. For example, different color coding may be applied to the durations displayed to indicate relative priority of resolving the corresponding interactions, and different color coding may be applied to the sentiments to indicate which interactions are positive, which interactions are negative and which interactions are neutral. In embodiments, the interactions displayed in live engagement panel 410 may be sorted and displayed according to a composite priority score for resolution, indicating to a user of supervisor system 110 which interactions may be highest priority for being resolved in order to maintain high overall customer satisfaction. The composite priority score may be calculated using factors including sentiment, experience, duration, topics, customer value or any other factor or characteristics of the interactions.

A supervisor may use the information of supervision display 400 to make judgments on what the supervisor feels is the most important to attend to. For example, the supervisor can hover over a particular interaction to get a real-time view of the interaction taking place. The supervisor can read a live transcript which will help to understand if the interaction is continuing to trend negatively or positively. For an interaction assigned to a human agent, the supervisor can proceed to monitor the human agent's workspace and see the communication between the agent and the customer as well as any of the agent assist help that the human agent is receiving. The supervisor can then proceed to communicate directly with the human agent, take over the interaction, or even modify the information being provided by an AI agent assist used by the human agent.

In embodiments, supervision display 400 may provide a supervisor a view of a current live interaction including access to the live transcript of the interaction, which enables the supervisor to have a real-time understanding of the interaction, including access to any of the information the agent is receiving from AI or any other agent assist tools (in addition to the live interaction with the customer). As needed, the supervisor can reach out to the agent to further assist or even take over the conversation, such as by selecting a particular interaction of the supervision display.

Supervision display 400 can also enable a supervisor to intervene during an AI agent interaction with end users or customers. For example, for a particular integration assigned to an AI agent, a supervisor could identify that the customer is simply in need of some empathy and suggest that the AI agent offer a discount or partial refund as an apology for the issues experienced by the customer. The supervisor could also suggest the AI agent ask an additional troubleshooting question if the supervisor believes the AI agent missed something that may be more obvious to the supervisor.

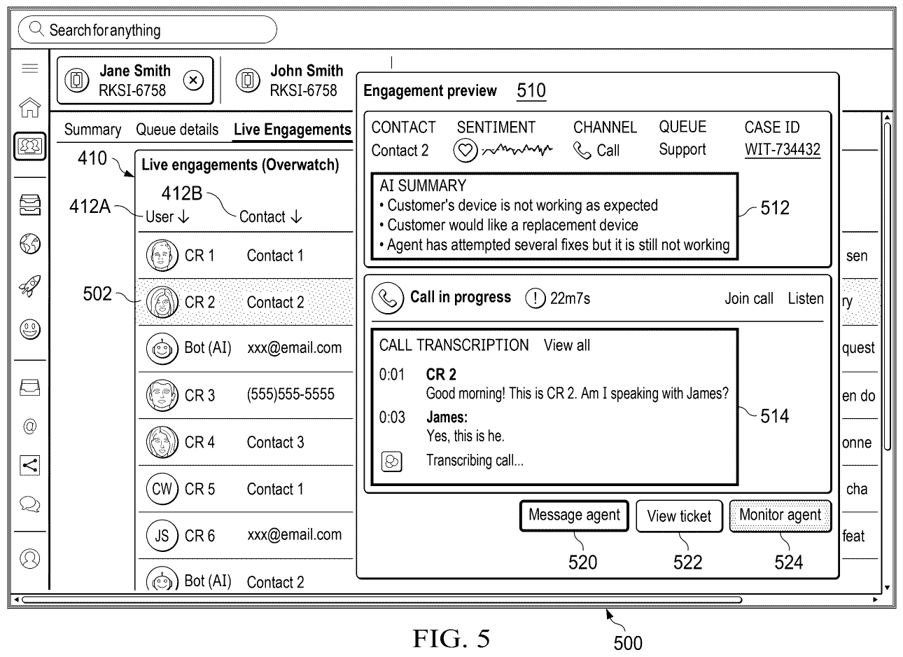

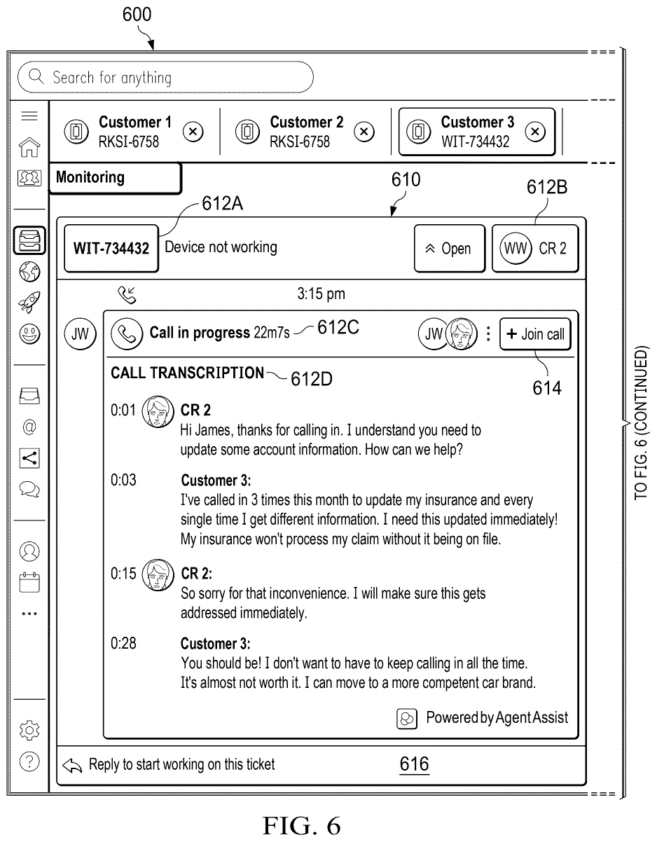

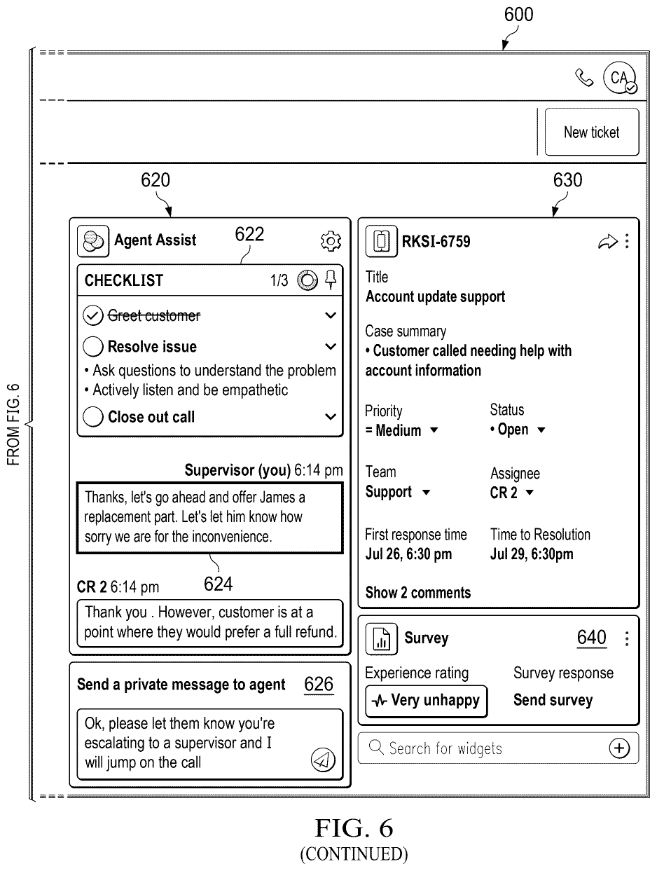

Supervision display 400 is configured to enable a user to select an interaction to view additional details, such as by displaying additional screens, displays or panels. For example, upon selection of a particular interaction or ticket, the user interface may be updated to display an engagement preview display, such as engagement preview display 500 of FIG. 5 below, or an intervention display, such as intervention display 600 of FIG. 6 below.

FIG. 5 illustrates engagement preview display 500, according to an embodiment. Engagement preview display 500 may be generated by supervisor system 110 of FIG. 1 and displayed via user interface module 206 as described in further detail above. In embodiments, engagement preview display 500 may be displayed to a supervisor of interaction system 100, such as a customer service supervisor or a customer relationship management supervisor.

Engagement preview display 500 may comprise supervision display 400 of FIG. 4 overlaid with preview panel 510, according to embodiment, and may be displayed in response to the selection of a particular interaction shown in supervision display 400. In the illustrated example, the user has selected second interaction 502, which is assigned to human agent CR (Customer Rep) 2. Preview panel 510 displays additional details about selected interaction 502, including detailed AI summary 512 of the interaction and complete transcription 514 of the interaction, which is this case is an auto-generated transcript of audio data captured via a phone call. Preview panel 510 includes various intervention options to the user including “message agent” button 520, “view ticket” button 522 and “monitor agent” button 524.

Engagement preview display 500 is configured to enable the user to select an interaction for intervention, such as by displaying additional screens, displays or panels. For example, upon selection of “monitor agent” button 524, the user interface may be updated to display an intervention display, such as intervention display 600 of FIG. 6 below.

FIG. 6 illustrates intervention display 600, according to an embodiment. Intervention display 600 may be generated by supervisor system 110 of FIG. 1 and displayed via user interface module 206 as described in further detail above. In embodiments, intervention display 600 may be displayed to a supervisor of interaction system 100, such as a customer service supervisor or a customer relationship management supervisor.

In the illustrated example, intervention display 600 has been displayed in response to a user selecting “monitor agent” button 524 of engagement preview display 500 of FIG. 5.

Intervention display 600 includes various panels allowing the user to further examine details of this interaction and intervene as needed, including activity panel 610, agent assist panel 620, case ID panel 630 and survey panel 640. Activity panel 610 includes ticket title 612A, customer ID 612B, interaction duration 612C and transcript 612D of the interaction, and further includes input options displayed to the user including “join call” button 614 and text input box 616 allowing the user to reply and add messages to the ticket. In embodiments, when an intervention from a supervisor takes place, activity panel 610 may be updated to indicate when the intervention occurred (not shown in illustration). For example, if the supervisor suggests that the agent try a troubleshooting step, activity panel 610 may be updated to indicate when this suggestion occurred, so that the activity may be more fully reviewed later. In such embodiments, the intervention shown in activity panel 610 may be selected to direct the user to the messages sent from the supervisor via agent assist panel 620 to give a clear understanding of what happened during the interaction.

Agent assist panel 620 includes checklist of interaction goals 622 indicating which goals have and have not yet been completed and message history 624 between the user and the customer service agent assigned to the ticket. Agent assist panel 620 includes input options displayed to the user including private message input box 626 allowing the agent to privately message the user. In this example, the user has entered a message into private message input box 626 which has not yet been sent to the agent.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A system for intervening in customer service interactions, comprising:
a computer, comprising a processor and memory, and configured to:
monitor open interactions between one or more agent systems and one or more customer devices;
track a duration of the open interactions to determine a relative priority for resolution, and assign a resolution priority to the open interactions based on the duration per communication type;
sort the open interactions based on one or more interaction characteristics;
generate and present a user interface comprising the sorted open interactions; and
transmit data to at least one agent system.

2. The system of claim 1, wherein the computer is further configured to:
generate a composite priority score for each open interaction based on the one or more interaction characteristics.

3. The system of claim 1, wherein the one or more interaction characteristics comprise one or more of: communication channel, duration and sentiment.

4. The system of claim 1, wherein the transmitted data comprises one or more instructions or commands for one or more artificial intelligent agents.

5. The system of claim 1, wherein the transmitted data comprises one or more intervention instructions.

6. The system of claim 1, wherein interaction data of the open interactions comprises one or more of: agent names or identification of agents, customer contact information, interaction category, duration, communication channel and transcripts.

7. The system of claim 1, wherein the user interface comprises a live transcript of at least one of the open interactions.

8. A computer-implemented method for intervening in customer service interactions, comprising:
monitoring, by a computer comprising a processor and memory, open interactions between one or more agent systems and one or more customer devices;
tracking, by the computer, a duration of the open interactions to determine a relative priority for resolution, and assigning, by the computer, a resolution priority to the open interactions based on the duration per communication type;
sorting, by the computer, the open interactions based on one or more interaction characteristics;
generating and presenting, by the computer, a user interface comprising the sorted open interactions; and
transmitting, by the computer, data to at least one agent system.

9. The computer-implemented method of claim 8, further comprising:
generating, by the computer, a composite priority score for each open interaction based on the one or more interaction characteristics.

10. The computer-implemented method of claim 8, wherein the one or more interaction characteristics comprise one or more of: communication channel, duration and sentiment.

11. The computer-implemented method of claim 8, wherein the transmitted data comprises one or more instructions or commands for one or more artificial intelligent agents.

12. The computer-implemented method of claim 8, wherein the transmitted data comprises one or more intervention instructions.

13. The computer-implemented method of claim 8, wherein interaction data of the open interactions comprises one or more of: agent names or identification of agents, customer contact information, interaction category, duration, communication channel and transcripts.

14. The computer-implemented method of claim 8, wherein the user interface comprises a live transcript of at least one of the open interactions.

15. A non-transitory computer-readable storage medium embodied with software for intervening in customer service interactions, the software when executed by a computer is configured to:
monitor open interactions between one or more agent systems and one or more customer devices;
track a duration of the open interactions to determine a relative priority for resolution, and assign a resolution priority to the open interactions based on the duration per communication type;
sort the open interactions based on one or more interaction characteristics;
generate and present a user interface comprising the sorted open interactions; and
transmit data to at least one agent system.

16. The non-transitory computer-readable storage medium of claim 15, wherein the software when executed is further configured to:
generate a composite priority score for each open interaction based on the one or more interaction characteristics.

17. The non-transitory computer-readable storage medium of claim 15, wherein the one or more interaction characteristics comprise one or more of: communication channel, duration and sentiment.

18. The non-transitory computer-readable storage medium of claim 15, wherein the transmitted data comprises one or more instructions or commands for one or more artificial intelligent agents.

19. The non-transitory computer-readable storage medium of claim 15, wherein the transmitted data comprises one or more intervention instructions.

20. The non-transitory computer-readable storage medium of claim 15, wherein interaction data of the open interactions comprises one or more of: agent names or identification of agents, customer contact information, interaction category, duration, communication channel and transcripts.
